(19) United States
(12) Patent Application Publication
(10) Pub. No.: US 2005/0228752 A1
(43) Pub. Date: Oct. 13, 2005

(54) System and method for managing encrypted multimedia content with an information handling system

(76) Inventors: David Konetski, Austin, TX (US); Neeraj Srivastava, Austin, TX (US)

Correspondence Address: Robert W. Holland;HAMILTON & TERRILE, LLP, PO Box 203518, Austin, TX, 78720, US

(21) Appl. No.: 10/819,413

(22) Filed: Apr. 7, 2004

(51) Int. Cl. G06F 17/60

(52) U.S. Cl. 705/51

(57) ABSTRACT

Robust presentation of protected content at an information handling system is supported by a content protection model that transcribes content from external encryption schemes to an internal rendering encryption scheme for transfer of the protected content across user-accessible buses to rendering subsystems that present the content. Content encrypted in one of plural proprietary content protection schemes is transcribed by a content transcription engine that applies an updateable protection scheme transcript table to decrypt the content from the proprietary scheme to a common scheme supported by rendering subsystems. A content rights mapping engine applies a content rights map to map user rights to the content from the external to the internal content protection schemes.

### BACKGROUND OF THE INVENTION

1. Field of the Invention

The present invention relates in general to the field of information handling system presentation of multimedia content, and more particularly to a system and method for managing encrypted multimedia content with an information handling system.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have increasingly become a repository for media content due in part to their innate content organizational capabilities. Many users commonly store home movies from camcorders on information handling system hard disc drives, such as for rendering onto other storage media like CDs and DVDs. Another common use of information handling systems is the storage of music copied from purchased CDs or downloaded from the Internet. The increasing availability of broadband Internet access and file sharing programs have made the Internet a popular tool for exchanging music, often without proper authorization. As advancing technology continues to improve data transfer rates, sharing of even larger files, such as DVD movies, is expected to increase. In response, the entertainment, software and information handling system industries have grappled with a variety of techniques for protecting content from unauthorized distribution. Currently, protected content distributed on the Internet is generally encrypted with various proprietary encryption techniques in a Digital Rights Management scheme that defines a user's rights to the content. For instance, some of the proprietary content protection systems available or in development include Helix by Real Networks, Windows Media Rights Management by Microsoft, Fairplay by Apple, DTCP by the DTLA, and HDCP by Intel. Other non-proprietary content protection systems include AES, DES, Triple DES and MPEG 21. In addition, as information handling systems transition towards the broader role of consumer media consumption devices, digital cable compatibility rules and High Definition Broadcast rules will also play a role in the system for protecting content on information handling systems.

One difficulty presented to information handling system manufacturers by the disparate content protection schemes is ensuring that content protection for each scheme is sufficiently robust. Robustness rules for the various schemes define how the encrypted data and its unencrypted sources are handled in computing and rendering environments. Generally, robustness rules require that unencrypted data not traverse user-accessible buses. The impact of such robustness rules on information handling system architecture and operation is that decryption engines are typically incorporated in hardware, firmware or software of rendering subsystems, such as video or audio cards. However, such distributed rendering subsystem decryption engines are unwieldy, difficult to implement, costly and lack the flexibility to adapt to different types of content protection schemes. For instance, incorporation of a newly developed content protection scheme in an existing information handling system having distributed decryption engines may require hardware redesign or card firmware re-flash. Maintaining information handling systems with evolving content protection schemes and backwards compatibility with pre-existing content protection schemes presents a substantial logistical problem given the wide variety of subsystems installed on information handling systems.

### SUMMARY OF THE INVENTION

Therefore a need has arisen for a system and method which flexibly implements disparate content protection schemes on an information handling system in a robust manner.

In accordance with the present invention, a system and method are provided which substantially reduce the disadvantages and problems associated with previous methods and systems for implementing disparate content protection schemes on an information handling system. A transcription engine transcribes the content protection scheme associated with protected content from an external encryption scheme to an internal encryption scheme that is supported by information handling system rendering subsystems. The protected content is sent through the information handling system with the internal rendering encryption scheme so that robustness of the content is maintained.

More specifically, an information handling system accepts protected content into a content protection module that transcribes the protected content's content protection scheme from an external proprietary content protection scheme to a non-proprietary internal rendering content protection scheme. The rendering content protection scheme is supported by rendering systems of the information handling system and allows transmission of the protected content through user-accessible buses without compromising the robustness of the system content protection. A content protection scheme transcription table maintains a mapping of current transcription protocols from external encryption schemes to the rendering encryption scheme. This system easily supports periodic updates to the content protection schemes supported by the information handling system without requiring changes to the rendering systems of the information handling system. A content rights state machine maps user rights from the external to the rendering protection schemes.

The present invention provides a number of important technical advantages. One example of an important technical advantage is that disparate content protection schemes are managed with desired robustness through centralized transcription that distributes content to rendering subsystems with a common content protection scheme. Robustness is maintained and protected content processed, even when a rendering subsystem fails to support the content's specific protection scheme, by transcribing the content to non-proprietary content protection scheme that subsystem manufacturers may commonly support. New content protection schemes or updates to existing content protection schemes are supported without rendering subsystem changes by updating the transcription engine with the new or updated scheme and communicating the content transcribed to a non-proprietary scheme readable by the rendering subsystems.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system configured to transcribe content from a first to a rendering content protection scheme.

### DETAILED DESCRIPTION

Content protected by an encryption scheme is processed by an information handling system in a robust and manageable manner by transcribing the content to an encryption scheme supported by the rendering subsystems of the information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

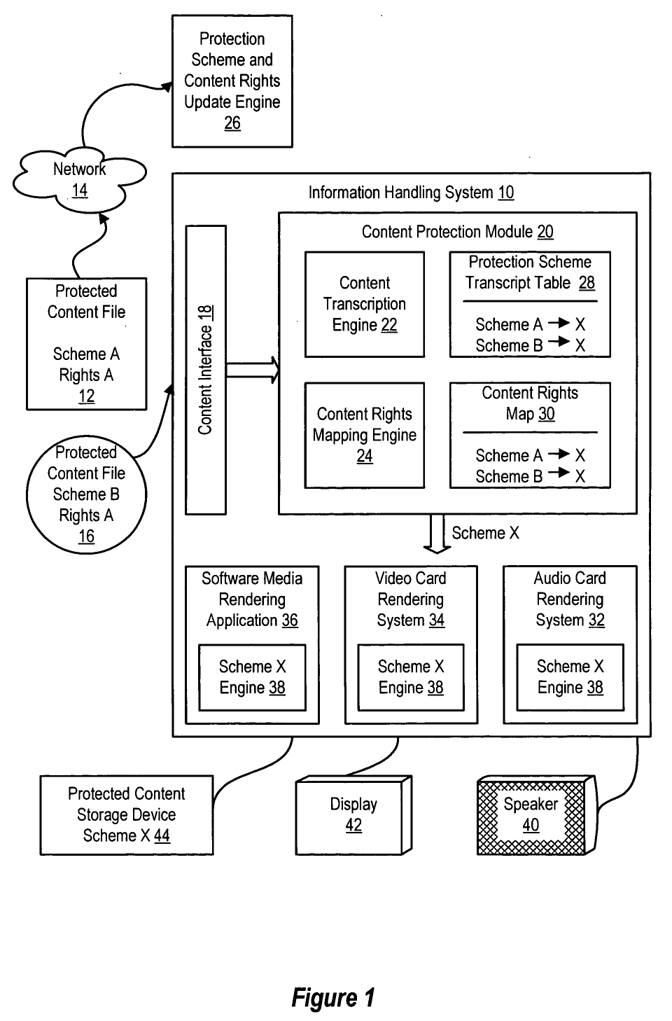

Referring now to FIG. 1, a block diagram depicts an information handling system 10 configured to process protected content in a robust manner. For example, protected content is communicated to information handling system 10 as electronic files 12 communicated through network 14, such as the Internet, or communicated from optical medium 16, such as CD or DVD. The content of file 12 is protected by a content encryption scheme A having user rights for processing of the content defined by a Rights scheme A. The content of file 16 is protected by a content encryption scheme B having user rights for processing of the content defined by a Rights scheme B. As an example, files 12 and 16 are an encrypted musical song and movie respectively which the user, has the right to play a predetermined number of times. Content protection schemes A and B each require robustness at an information handling system that restrict transfer of decrypted information over user accessible buses of information handling system 10. Thus, conventional decryption of files under schemes A and B normally occurs at the rendering subsystems of the information handling system, such as the audio and video cards.

Information handling system 10 accepts the protected content at a content interface 18 and provides the protected content to a content protection module 20. Content protection module 20 is a secure application running on the CPU of information handling system 10 that is not accessible by the user and that does not communicate unencrypted information over any user-accessible bus. Content protection module 20 may instantiate within a media application or run as a separate application. A content transcription engine 22 reads the protected content in the external encryption scheme, decrypts the content, and re-encrypts the content in an internal encryption scheme supported by the rendering subsystems of information handling system 10. Content re-encrypted in the rendering content protection scheme, labeled scheme X in FIG. 1, may be transferred through user-accessible buses without compromising the robustness of the content protection. As an example, content protected by a proprietary external content protection scheme, such as the Helix or WMRM content protection schemes, is decrypted and re-encypted by content transcription engine 22 into a non-proprietary scheme, such as AES or DES, that is readily supported by rendering subsystems.

In addition to transcription of protected content, content protection module 20 includes a content rights mapping engine 24 that maps content rights for a protected content from the rights defined by the external protection scheme to the rights defined by the internal protection scheme. Content rights mapping engine 24 transfers rights information, such as use rights associated with content like permitted copying or number of plays, from one protection scheme to another. For instance, rights associated with the external scheme, labeled as Rights A and B, are transferred to an internal scheme, labeled Rights X by direct mapping, mapping down or mapping up, depending upon a desired rights policy. For instance, in some situations where rights do not track exactly from the external to the common rendering scheme, content rights mapping engine 24 acts as a state machine that maps down from greater rights in the external scheme to lesser rights in the internal scheme and regenerates re-encrypted content until the rights defined by the external scheme expire.

One important advantage of content protection module 20 is that new content protection schemes are supported by information handling system 10 by updating the capability of content transcription engine 22 to transcribe from the new scheme to the common rendering scheme. For instance, a protection scheme and content rights update engine 26 interfaces through network 14 with content protection module 20 to update the transcription and content rights definitions applied by content transcription engine 22 and content rights mapping engine 24. A content protection scheme transcription table 28 maintains a current list of transcriptions from external content protection schemes to the one or more internal content protection schemes supported by rendering systems. A content rights map 30 maintains a current list of mappings from external content rights schemes to the content rights defined by the one or more internal content protection schemes supported by the rendering systems. Protection scheme and content rights update engine 26 updates newly supported external schemes in table 28 and map 30, such as with regular maintenance queries sent to an update server interfaced with the Internet.

Once information handling system 10 re-encrypts content to a scheme supported by the rendering systems, Scheme X in FIG. 1, the protected content may be transferred across user-accessible buses without risk to the robustness of the content. For instance, content protected under Scheme X is sent to an audio card rendering system 32 for rendering audio content on speakers 40 or to a video card rendering system 34 for playing video content on a display 42. Each rendering system includes a Scheme X engine 38 that decrypts the protected content from the rendering protection scheme for presentation to a user. Alternatively, a software media rendering application 36 prepares content for presentation or storage in a protected content storage device 44 using the rendering protection scheme. Software media rendering application 36 recalls the stored content for subsequent use by audio and video rendering systems.

Although the present invention has been described in detail, it should be understood that various changes, substitutions and alterations can be made hereto without departing from the spirit and scope of the invention as defined by the appended claims.

1. An information handling system comprising:
a content interface operable to accept content protected by one or more of plural content protection schemes;
a content transcription engine operable to decrypt the content from the one or more of plural content protection schemes and to re-encrypt the content to a rendering content protection scheme; and
a rendering system interfaced with the content transcription engine and operable to decrypt the rendering content protection scheme for presentation of the content.

2. The information handling system of claim 1 further comprising:
a contents rights mapping engine operable to determine content rights associated with the content in the one or more of plural content protection schemes and to map the content rights to the rendering content protection scheme.

3. The information handling system of claim 2 wherein the rendering system comprises:
a rendering content protection scheme decrypt engine operable to decrypt the content at the rendering system; and
an audio card rendering system interfaced with the rendering content protection scheme decrypt engine and operable to play the decrypted content as audio signals.

4. The information handling system of claim 2 wherein the rendering system comprises:
a rendering content protection scheme decrypt engine operable to decrypt the content at the rendering system; and
a video card rendering system interfaced with the rendering content protection scheme decrypt engine and operable to render the decrypted content as video signals.

5. The information handling system of claim 2 wherein the one or more of plural content protection schemes comprises proprietary content protection schemes and the rendering content protection scheme comprises an open content protection scheme.

6. The information handling system of claim 2 further comprising:
a protection scheme and content rights update engine interfaced with the content interface and operable to update the content transcription engine and content rights mapping engine to transcribe from a new content protection scheme to the rendering content protection scheme.

7. The information handling system of claim 1 wherein the content comprises a file downloaded from a network.

8. The information handling system of claim 1 wherein the content comprises a file downloaded from an optical medium.

9. The information handling system of claim 1 further comprising a protected content storage device interfaced with the content transcription engine and operable to store the content in the rendering protection scheme.

10. A method for presenting protected content at an information handling system, the method comprising:
receiving content at the information handling system, the content protected by a first encryption scheme;
decrypting the protected content within a secure portion of the information handling system;
re-encrypting the protected content to a second encryption scheme within the secure portion of the information handling system;
communicating the protected content with the second encryption scheme to a rendering system;
decrypting the protected content from the second encryption scheme at the rendering system; and
presenting the protected content with the rendering system.

11. The method of claim 10 further comprising:
storing the protected content on the information handling system in the second encryption scheme.

12. The method of claim 10 wherein the first encryption scheme comprises one of plural proprietary encryption schemes and the second encryption scheme comprises an open encryption scheme.

13. The method of claim 12 further comprising:
looking up a transcription for the first to the second encryption schemes from a transcription table; and
applying the transcription to perform the decrypting and re-encrypting of the content.

14. The method of claim 13 further comprising:
looking up a content rights map for the first to the second encryption schemes; and
mapping content rights for the content in the first encryption scheme to content rights in the second encryption scheme.

15. The method of claim 14 further comprising:
updating the transcription table and content rights map with a new content protection encryption scheme; and
applying the updated transcription table and content rights map to convert content from the new content protection encryption scheme to the second content protection encryption scheme.

16. The method of claim 10 wherein presenting the content further comprises outputting audio content from an audio card of the information handling system.

17. The method of claim 10 wherein presenting the content further comprises displaying video content from a video card of the information handling system.

18. A system for robust presentation of protected content at an information handling system having a rendering system receiving the content through a user-accessible bus, the system comprising:
a content transcription engine operable to accept the content encrypted in a first of plural content protection schemes and to transcribe the content to a rendering encryption scheme;
a user accessible bus interfaced with the content transcription engine and operable to transfer the transcribed content; and
a content rendering system interfaced with the user accessible bus and operable to decrypt the rendering encryption scheme to present the content.

19. The system of claim 18 further comprising a protection scheme transcription table defining transcription from each of the plural content protection schemes to the rendering encryption scheme, wherein the content transcription engine is further operable to update the protection scheme transcription table with new content protection transcriptions to the rendering encryption scheme.

20. The system of claim 18 further comprising:
a content rights map operable to map content rights from the plural content protection schemes to the rendering encryption scheme; and
a content rights mapping engine operable to map a content rights state of the first protection scheme to a content rights state of the rendering encryption scheme.
